(19) United States
(12) Patent Application Publication
(10) Pub. No.: US 2020/0049813 A1
(43) Pub. Date: Feb. 13, 2020

(54) POSITIONING SYSTEM FOR HYPERLOOP TRANSPORTING

(71) Applicant: AUTO DRIVE SOLUTIONS, S.L., Madrid (ES)

(72) Inventor: Alejandro BADOLATO MARTIN, Madrid (ES)

(73) Assignee: AUTO DRIVE SOLUTIONS, S.L., Madrid (ES)

(21) Appl. No.: 16/603,313

(22) PCT Filed: Apr. 10, 2017
(86) PCT No.: PCT/IB2017/052056

§ 371 Date: Oct. 7, 2019

(51) Int. Cl. G01S 13/75; G01S 13/91; B61B 13/10; B61L 25/02

(52) U.S. Cl. CPC G01S 13/751; B61L 25/02; B61B 13/10; G01S 13/91

(57) ABSTRACT

The present invention relates to a positioning system for the hyperloop means of transport that comprises a group of readers installed on the pod that query the infrastructure by means of electromagnetic or pressure waves. Along the length of the route of the tube through which the pod travels, there is information encoded by passive elements that make up a message that is readable by the sensors. Once the message has been decoded, it is possible to determine the longitudinal forward movement of the pod and its rotation with respect to the longitudinal axis of the tube, because the tube presents different information encoded both longitudinally and angularly.

### OBJECT OF THE INVENTION

The disclosed invention relates to a positioning system for the hyperloop means of transport.

The system uses a group of sensors installed on the sheath or pod that query the infrastructure by means of electromagnetic or pressure waves.

Along the length of the route of the tube through which the pod travels, there is information encoded by passive elements that make up a message that is readable by the sensors.

Once the message has been decoded, it is possible to determine the longitudinal forward movement of the pod and its rotation with respect to the longitudinal axis of the tube. In addition to reading the recorded messages, the sensors are able to determine whether the pod is traveling along the center of the tube or whether, on the other, hand, there is axial displacement.

### FIELD OF THE INVENTION

The field of the invention is that of obtaining the positioning of high-speed transports in regard to both length and both longitudinal and axial displacement.

### BACKGROUND OF THE INVENTION

There is some prior art on devices that perform a similar function for other means of transport. Of these, the inventor is likewise the inventor of international patent PCT/ES2015/070378 which describes as a means of encoding a rail-0 guide installed at the level of the roadway surface although optionally it may be hidden under a layer of asphalt treated with a layer of hydrophobic material with preferable dimensions of 1.5 cm wide by 5 cm deep and wherein hollows are machined inside the same, with the preferred shape of the hollows being that of dihedrals because the planes of the dihedrals increase the reflected signal therefore facilitating its detection.

The same inventor has also presented a similar system applicable among others to the railway industry in PCT/IB2016/051 159.

However, these inventions are not optimum for a means of transport such as hyperloop where both the rotation of the pod with respect to the longitudinal axis of the tube as well as the axial displacement of the pod with respect to the same longitudinal axis must be controlled. The inventor is not aware of any prior art that incorporates the provisions that are presented by this invention or the advantages that are generated by this provision.

### DESCRIPTION OF THE INVENTION

The disclosed invention relates to a system for determining the position of the pod inside the tube in the hyperloop means of transport.

The system uses a group of sensors installed on the sheath or pod that query the infrastructure by means of electromagnetic or pressure waves.

Along the length of the route of the tube through which the pod travels, there is information encoded by passive elements that make up a message that is readable by the sensors.

Once the message has been decoded, it is possible to determine the longitudinal forward movement of the pod and its rotation with respect to the longitudinal axis of the tube, because the tube presents different information encoded both longitudinally and angularly.

In addition to reading the recorded messages, the sensors are able to determine whether the pod is traveling along the center of the tube or whether, on the other, hand, there is axial displacement.

### PREFERRED EMBODIMENT OF THE INVENTION

The positioning system for the hyperloop means of transport is made up of a group of radar sensors that query the infrastructure by means of electromagnetic or pressure waves and measure the different distances to the boundaries of dielectric change or to the metal dielectric boundaries in order to:
determine the axial displacement of the pod with respect to the tube,
determine the longitudinal forward movement of the pod along the length of the tube
determine the rotation of the pod with respect to the longitudinal axis of the tube.

In a particular embodiment, the positioning system is made up of four millimeter wave radar sensors coupled to both sides, on the roof and on the floor of the pod, which concentrate the energy that they radiate onto one square centimeter of surface area of the tube with the help of a lens and measure the distance from the exterior hull of the pod to the internal wall of the tube, being able to determine the possible axial displacement.

The internal wall of the tube is lined with a plastic material that is permeable to waves.

The plastic material has two layers of the same material stuck to each other with a glue that has a different dielectric constant.

This dielectric discontinuity causes a reflection that the radar uses to measure the thickness of the layer closest to the pod because in the discontinuity between the inside of the tube and the plastic, there is another discontinuity that causes another reflection.

These thicknesses are modified in steps along the longitudinal axis of the tube in 2 cm sections, encoding several logic levels.

These logic levels will be the following:

1. Bit 0, Start bit, Stop bit and repeated bit. by means of thicknesses of the external layer (the one closest to the pod), of 1, 2, 3, 4 and 5 cm, respectively.

The repeated bit, applied in an alternating manner, makes it possible to identify consecutive sequences with the same logic level.

When the sensor measures this thickness, it associates the logic level with the previous bit.

The information bits are grouped in groups of 4 by 4 forming a single piece.

Since only 4 bits are encoded per piece, 16 different pieces are obtained.

The 4 bits of each piece are preceded by one start bit and finish with one stop bit.

The plastic pieces (toroids obtained by the rotation of a rectangle) are combined to form 32-bit words.

A seventeenth model of plastic piece encoded analogically identifies the start and end of a word. This piece is characterized in that its first bit after the start bit is a repeated bit.

In addition to the longitudinal encoding, a second angular encoding, enables the sensors to identify the rotation of the pod with respect to the longitudinal axis.

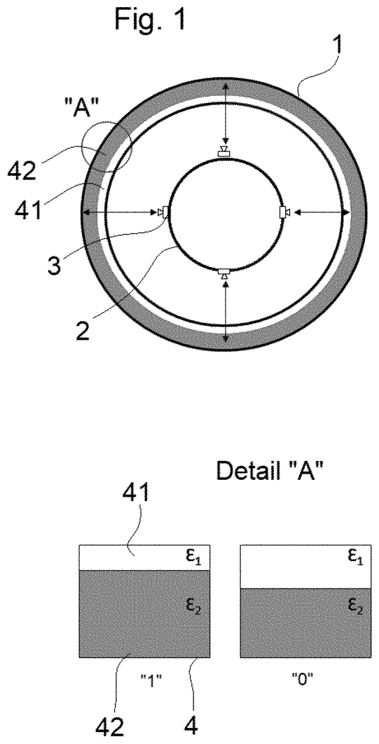

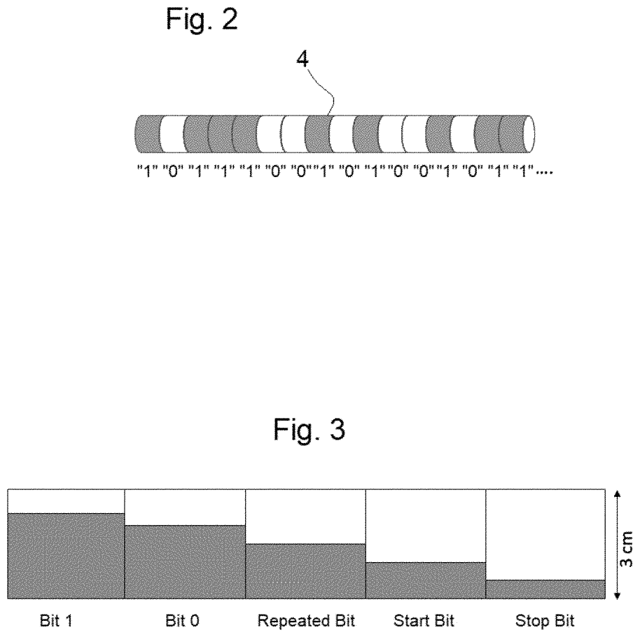

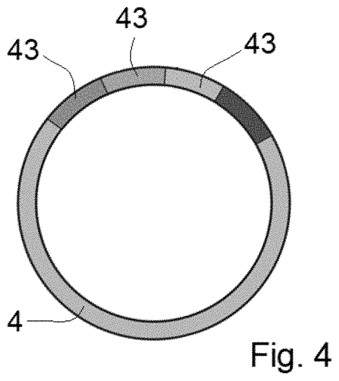

The plastic pieces have different angular tracks as shown in FIG. 1 where each track encodes a different sequence of data.

Another two groups of thicknesses are used to represent the same logic levels 1, 0, Repeated, Start and End.

A second group thus encodes the information in the interval of thicknesses between 6 and 10 cm, and a third group encodes in the interval between 11 and 15 cm.

The consecutive angular tracks alternate the set of logical levels.

For example,
The track corresponding to 0 degrees of rotation uses logic level group 1,
The track corresponding to 1 degree of rotation uses logic level group 2,
The track corresponding to 2 degrees of rotation uses logic level group 3, and
the track corresponding to 3 degrees of rotation once again uses group 1.

This means that when the sensor is aimed between two adjacent tracks, the sensor is able to read both tracks without the information from one track interfering with the reading of the other.

Each track, in addition to the 4 bits of longitudinal information, contains another 10 bits that identify the track number.

This means that each one of the 16 different pieces contains a group of tracks wherein each one encodes 16 bits longitudinally: 1 start bit, 4 bits for longitudinal forward movement, 10 bits for track identification and one stop bit. The 4 bits of longitudinal information are interspersed among the bits that encode the track number in known positions.

Having described the nature of the invention sufficiently, and also the way in which it can be put into practice, it is hereby stated that the provisions indicated above and represented in the attached drawing may be changed in in terms of details provided that they do not change the fundamental principle, established in the previous paragraphs and summarized in the claims below.

1-8. (canceled)

9. A system for determining the position of a pod (2) inside a Hyperloop tube (1) of a Hyperloop means of transportation, the system comprising:
a group of four millimeter-wave radar sensors (3) coupled to both sides, on a roof and on a floor of the pod (2), which concentrate the energy that the group of four millimeter-wave radar sensors radiate onto one square centimeter of surface area of the Hyperloop tube (1) of the Hyperloop means of transportation and along with a len(s), measure distance from an exterior hull of the pod (2) to an internal wall of the Hyperloop tube, in order to determine:
the axial displacement of the pod with respect to the Hyperloop tube,
the longitudinal forward movement of the pod along the length of the Hyperloop tube,
the rotation of the pod with respect to the longitudinal axis of the Hyperloop tube; and
a series of passive elements, arranged along the length of the Hyperloop tube (1) through which the pod (2) travels, which include encoded information that makes up a message that is readable by the group of four millimeter-wave radar sensors (3), so that once said message has been decoded, it is possible to determine the longitudinal forward movement of the pod and its rotation with respect to the longitudinal axis of the Hyperloop tube, because the Hyperloop tube presents different encoded information both longitudinally and angularly, wherein
said series of passive elements are made up of a lining made of a plastic material (4) that is permeable to the waves that lines the inside of the Hyperloop tube, which presents a variable thickness.

10. The system, according to claim 9, wherein
the lining (4) made of plastic material is made up of two layers (41, 42) of the same material stuck to each other with a glue that have a different dielectric constant, with this dielectric discontinuity causing a reflection that the radar uses to measure the thickness of the layer (41) closest to the pod because in the discontinuity between the inside of the Hyperloop tube (1) and the plastic (4), there is another discontinuity that causes another reflection.

11. The system, according to claim 10, wherein
the thickness (ε1) of the layer (41) closest to the pod (2) is modified in steps, encoding different logic levels: bit 1, bit 0, start bit, stop bit and repeated bit, by means of variation of the thicknesses of the external layer (41) (the one closest to the pod) of 1, 2, 3, 4 and 5 cm, respectively; wherein
the repeated bit, used in an alternating manner, makes it possible to identify consecutive sequences with the same logic level and when the group of four millimeter-wave radar sensor measures this thickness, it associates the logic level with the previous bit.

12. The system, according to claim 11, wherein
the information bits are grouped by groups of 4 by 4, forming a single piece, and since 4 bits are encoded per piece, obtaining 16 different pieces, of plastic (toroids obtained by the rotation of a rectangle) that are combined to form 32-bit words, while a seventeenth model of plastic piece encoded analogically identifies the start and end of a word, with the first bit of this piece being after the start bit and a repeated bit.

13. The system, according to claim 9, wherein
in addition to the longitudinal encoding, a second angular encoding enables the group of four millimeter-wave radar sensors to identify the rotation of the pod with respect to the longitudinal axis due to the fact that the plastic pieces present different angular tracks wherein each track encodes a different sequence of data.

14. The system, according to claim 13, wherein
three groups of thicknesses are used to code each one of the logic levels for the angular encoding: Bit 1, Bit 0, Repeated Bit, Start Bit and Stop Bit, with the angular tracks alternating consecutively in a group of logic levels with the following sequence of groups: 1, 2, 3, 1, 2, 3, 1, 2, . . . , until the revolution has been completed.

15. The system, according to claim 9, wherein
each track, in addition to the 4 bits of longitudinal information, contains another 10 bits that identify the track number, such that each one of the 16 different pieces contains a group of tracks wherein each one encodes 16 bits longitudinally: 1 start bit, 4 bits for longitudinal forward movement, 10 bits for track identification and one stop bit, with the 4 bits of longitudinal information interspersed among the bits that encode the track number in known positions.

16. The system, according to claim 10, wherein
each track, in addition to the 4 bits of longitudinal information, contains another 10 bits that identify the track number, such that each one of the 16 different pieces contains a group of tracks wherein each one encodes 16 bits longitudinally: 1 start bit, 4 bits for longitudinal forward movement, 10 bits for track identification and one stop bit, with the 4 bits of longitudinal information interspersed among the bits that encode the track number in known positions.

17. The system, according to claim 11, wherein
each track, in addition to the 4 bits of longitudinal information, contains another 10 bits that identify the track number, such that each one of the 16 different pieces contains a group of tracks wherein each one encodes 16 bits longitudinally: 1 start bit, 4 bits for longitudinal forward movement, 10 bits for track identification and one stop bit, with the 4 bits of longitudinal information interspersed among the bits that encode the track number in known positions.

18. The system, according to claim 12, wherein
each track, in addition to the 4 bits of longitudinal information, contains another 10 bits that identify the track number, such that each one of the 16 different pieces contains a group of tracks wherein each one encodes 16 bits longitudinally: 1 start bit, 4 bits for longitudinal forward movement, 10 bits for track identification and one stop bit, with the 4 bits of longitudinal information interspersed among the bits that encode the track number in known positions.

19. The system, according to claim 13, wherein
each track, in addition to the 4 bits of longitudinal information, contains another 10 bits that identify the track number, such that each one of the 16 different pieces contains a group of tracks wherein each one encodes 16 bits longitudinally: 1 start bit, 4 bits for longitudinal forward movement, 10 bits for track identification and one stop bit, with the 4 bits of longitudinal information interspersed among the bits that encode the track number in known positions.

20. The system, according to claim 14, wherein
each track, in addition to the 4 bits of longitudinal information, contains another 10 bits that identify the track number, such that each one of the 16 different pieces contains a group of tracks wherein each one encodes 16 bits longitudinally: 1 start bit, 4 bits for longitudinal forward movement, 10 bits for track identification and one stop bit, with the 4 bits of longitudinal information interspersed among the bits that encode the track number in known positions.
